(19) United States
(12) Patent Application Publication
(10) Pub. No.: US 2007/0187876 A1
(43) Pub. Date: Aug. 16, 2007

(54) Injection stretch blow molding process using polylactide resins

(75) Inventors: Kevin Cink, Brooklyn Park, MN (US); Richard C. Bopp, Golden Valley, MN (US); Kevin D. Sikkema, Midland, MI (US)

Correspondence Address: GARY C. COHN, PLLC, 1147 NORTH FOURTH STREET, UNIT 6E, PHILADELPHIA, PA, 19123, US

(73) Assignee: NATUREWORKS LLC, Minnetonka, MN (US)

(21) Appl. No.: 11/629,733

(22) PCT Filed: Jun. 23, 2005
(86) PCT No.: PCT/US05/22629

§ 371 Date: Dec. 15, 2006

Related U.S. Application Data
(60) Provisional application No. 60/582,155, filed on Jun. 23, 2004.

(51) Int. Cl. B29C 49/06; B29C 49/10; B29C 49/64; B29C 49/22

(52) U.S. Cl. 264/510; 264/532; 264/535; 264/537

(57) ABSTRACT

Containers are manufactured in an injection stretch molding process using a PLA resin having a specified ratio of lactic acid stereoisomers and stretch ratios. The process permits good quality containers to be made at good operating rates.

This invention was made with United States Government support under Contract No. DE-FC36-00GO10598 awarded by the United States Department of Energy. The United States Government has certain rights in this invention.

This application claims priority from U.S. Provisional Patent Application No. 60/582,155, filed Jun. 23, 2004.

This invention relates to injection stretch blow molding processes for making containers.

Containers such as bottles are often molded from thermoplastic resins in an injection stretch blow molding process. Poly(ethylene terephthalate) (PET) bottles are made in very large quantities in this manner. The containers are often desirably clear and are commonly used to package drinks such as water and carbonated beverages. PET performs very well in this application, but has the drawbacks of being derived from oil-based materials and of not being biodegradable or compostable. There is an increasing interest in developing substitute polymeric materials that are derived from annually-renewable resources. Biodegradable or compostable materials are also of interest, because they break down relatively quickly if landfilled or composted under proper conditions. The containers can be disposed of as well as recycled, and thus provide a wider range of disposal/reuse options.

Polylactide resins (also known as polylactic acid or PLA) are now available commercially. These resins can be produced from annually renewable resources such as corn, rice or other sugar- or starch-producing plants. In addition, PLA resins are compostable. For these reasons there is significant interest in substituting PLA into applications in which oil-based thermoplastic materials have conventionally been used. To this end, it has been attempted to use PLA resins in an injection stretch blow molding process to produce containers. See, e.g., U.S. Pat. No. 5,409,751. However, PLA resins are difficult to process in injection stretch blow molding processes, as the PLA resins tend to have significantly different crystalline properties and much smaller processing windows than PET. PLA resins have so far proven to be difficult to process at high operating rates into good quality bottles. In some instances, the resin cannot be blown well at all. In other cases, the resin tends to stress whiten during the molding process, forming opaque rather than clear containers. In yet other cases, the PLA resin forms containers having a considerable lack of uniformity in the container wall thickness or forms a container having poor impact strength. As a result, the processing window that can be used to make injection stretch molded containers from PLA resins has been so narrow that PLA resins have not been used successfully in injection stretch blow molding processes. Other types of resins that are used in injection stretch molding processes have sometimes encountered similar problems. These can be overcome in some instances by making structural changes to the polymer, such as by incorporating a comonomer into the polymer backbone. However, modifications such as these also tend to change other polymer properties, such as the glass transition temperature, melt viscosity, solubility, permeability, chemical resistance or toxicity. For this reason, it is usually preferable to avoid making changes in the chemical structure of the polymer.

It would be desirable to provide a method by which PLA resins can be used to produce containers in an injection stretch blow molding process at good operating rates to produce good quality containers.

This invention is in one aspect an injection stretch blow molding process for making containers of a thermoplastic resin, in which a thermoplastic resin is molded to form a preform which is mechanically stretched and blown into a container mold to stretch the preform axially and radially and form a container, wherein (1) the thermoplastic is a polylactic acid (PLA) resin which is a copolymer having repeating L and D lactic acid units, in which either the L or D lactic acid units are the predominant repeating units, and the predominant repeating units constitute 90 to 99.5% of the lactic acid repeating units and (2) the product of axial and radial stretch ratios is from about 3 to about 17.5.

The injection stretch blow molding process of the invention may be either a one-step or two-step process, as described more fully below.

The selection of PLA resin having the stated enantiomer ratios provides significant benefits to the ISBM process, allowing for containers to be prepared with short cycle times, controlled crystallinity, good clarity, good toughness and impact resistance and uniform wall thicknesses. Processing windows are increased with the PLA resins having the stated isomer ratios, making it easier to produce good quality containers at high operating rates.

Containers are made in accordance with the invention using an injection stretch blow molding (ISBM) process. ISBM processes are known, being described, for example, in U.S. Pat. No. 5,409,751. The process involves first forming a preform, or “plug”, which is hollow and has dimensions a fraction of those of the final container. The preform is molded into a container by inserting it into a mold, and stretching it both axially (i.e. along its length) and radially. The axial stretching is done mechanically by inserting a pusher rod into the preform and mechanically extending it towards the bottom of the mold. Radial stretching is accomplished by injecting a compressed gas into the plug, thereby forcing the resin outward to contact the interior surface of the mold. Typically, a preliminary radial stretch is preformed by injecting a first increment of gas. This makes room for the stretcher rod, which can then be inserted. The preform is then stretched and immediately afterward is blown with more gas to complete the blow molding operation.

The axial strain (or axial stretch ratio) is typically about 1.5 to about 3.5, especially about 2 to about 3. The axial strain is considered to be the ratio of the container length to preform length. The radial or “hoop” strain (or hoop stretch ratio) is typically from about 2 to about 5, especially 3 to about 5, and is considered to be the ratio of the preform circumference to that of the container. Hoop strain is generally not constant for any particular container, as the container generally does not have a constant circumference. Unless specified otherwise, hoop ratio, for purposes of this invention, refers to the average hoop ratio for the side walls of the container.

Areal strain (or areal stretch ratio) is the product of axial strain times hoop strain, and is typically in the range of about 3 to about 17.5, such as from about 3 to about 15, about 5 to about 12 or about 8 to about 11.

ISBM processes are divided into two main types. One type is a one-step process, in which the preform is molded, conditioned, and then transferred to the stretch blow molding operation before the preform is cooled below its softening temperature. The other main type of ISBM process is a two-step process in which the preform is prepared ahead of time. In this case, the preform is reheated to conduct the stretch blow molding step. The two-step process has the advantage of faster cycle times, as the stretch blow molding step does not depend on the slower injection molding operation to be completed. However, the two-step process presents the problem of reheating the preform to the stretch blow molding temperature. This is usually done using infrared heating, which provides radiant energy to the outside of the preform. It is sometimes difficult to heat the preform uniformly using this technique and unless done carefully, a large temperature gradient can exist from the outside of the preform to the center. Conditions usually must be selected carefully to heat the interior of the preform to a suitable molding temperature without overheating the outside. The result is that the two-step process usually has a smaller operating window than the one-step process. The selection of a PLA resin as described herein has been found to broaden this processing window.

In the two-step process, the preform is generally heated to a temperature at which the preform becomes soft enough to be stretched and blown. This temperature is generally above the glass transition temperature (T_{g}) of the PLA resin. A preferred temperature is from about 70 to about 120° C. and a more preferred temperature is from about 80 to about 100° C. In order to help obtain a more uniform temperature gradient across the preform, the preform may be maintained at the aforementioned temperatures for a short period to allow the temperature to equilibrate.

Mold temperatures in the two-step process are generally below the glass transition temperature of the PLA resin, such as from about 30 to about 60° C., especially from about 35 to about 55° C. Sections of the mold such as the base where a greater wall thickness is desired may be maintained at even lower temperatures, such as from about 0 to about 35° C., especially from about 5 to about 20° C.

In the one-step process, the preform from the injection molding process is transferred to the stretch blow molding step, while the preform is at a temperature at which the preform becomes soft enough to be stretched and blown, again preferably above the T_{g} of the resin, such as from about 80 to about 120° C., especially from about 80 to about 110° C. The preform may be held at that temperature for a short period prior to molding to allow it to equilibrate at that temperature. The mold temperature in the one-step process may be above or below the T_{g} of the PLA resin. In the so-called “cold mold” process, mold temperatures are similar to those used in the two-step process. In the “hot mold” process, the mold temperature is maintained somewhat above the T_{g} of the resin, such as from about 65 to about 100° C. In the “hot mold” process, the molded part may be held in the mold under pressure for a short period after the molding is completed to allow the resin to develop additional crystallinity (heat setting). The heat setting tends to improve the dimensional stability and heat resistance of the molded container while still maintaining good clarity. Heat setting processes may also be used in the two-step process, but are used less often in that case because the heat setting process tends to increase cycle times.

Blowing gas pressures in either the one-step or two-step processes typically range from about 5 to about 50 bar (about 0.5 to about 5 MPa), such as from about 8 to about 45 bar (about 0.8 to about 4.5 MPa). It is common to use a lower pressure injection of gas in the preliminary radial stretch, followed by a higher pressure injection to complete the blowing process.

For the purposes of this invention, the terms “polylactide”, “polylactic acid” and “PLA” are used interchangeably to denote polymers having repeating units of the structure —OC(O)CH(CH₃)—, irrespective of how those repeating units are formed into the polymer. The PLA resin preferably contains at least 90%, such as at least 95% or at least 98%, by weight of those repeating units. The PLA resin used in this invention is typically a random polymer containing both D and L enantiomer repeating. units. When a single-step ISBM process is used, the predominant enantiomer constitutes from 90-99.5% of the polymerized lactic acid units and the other enantiomer constitutes from 0.5 to 10% of the polymerized lactic acid units. Suitable enantiomer ratios for the single-step process include, for example, 92-98% of the predominant enantiomer and 2-8% of the other enantiomer, 94-98% of the predominant enantiomer and 2-6% of the other enantiomer or 95-97% of the predominant enantiomer and 3-5% of the other enantiomer. It is most preferred that the PLA resin contains predominantly polymerized L lactic acid units, but it is equally within the scope of the invention to use a PLA resin containing predominantly D lactic acid units.

The PLA resin may be a blend of PLA resins, in which the average enantiomer ratios are within the aforementioned ranges. In particular, blends of one resin having an enantiomer ratio of 70:30 to 95:5, especially from 80:20 to 90:10, and another resin having an enantiomer ratio of 95:5 or greater, especially 97:3 or greater, are useful. The proportions of the constituent resins are selected to produce an average enantiomer ratio for the blend as a whole within the ranges described before. In some instances, the use of such a polymer blend is found to lead to improvements in properties such as reduced shrinkage and reduced strain whitening.

A preferred PLA resin is a polymer or copolymer of lactide. α-hydroxy acids such as lactic acid, exist as two optical enantiomers, which are generally referred to as the “D” and “L” enantiomers. Either D- or L-lactic acid can be produced in synthetic processes, whereas fermentation processes usually (but not always) tend to favor production of the L enantiomer. Lactide similarly exists in a variety of enantiomeric forms, i.e., “L-lactide”, which is a dimer of two L-lactic acid molecules, “D-lactide”, which is a dimer of two D-lactic acid molecules and “meso-lactide”, which is a dimer formed from one L-lactic acid molecule and one D-lactic acid molecule. In addition, 50/50 mixtures of L-lactide and D-lactide that have a melting temperature of about 126° C. are often referred to as “D,L-lactide”. Polymers of any of these forms of lactide, or mixtures thereof, are useful in this invention, provided that the PLA resin has the isomer ratio described above.

A preferred lactide is produced by polymerizing lactic acid to form a prepolymer, and then depolymerizing the prepolymer and simultaneously distilling off the lactide that is generated. Such a process is described in U.S. Pat. No. 5,274,073 to Gruber et al., which is incorporated herein by reference.

The PLA resin may further contain repeating units derived from other monomers that are copolymerizable with lactide or lactic acid, such as alkylene oxides (including ethylene oxide, propylene oxide, butylene oxide, tetramethylene oxide, and the like), cyclic lactones or cyclic carbonates. Repeating units derived from these other monomers can be present in block and/or random arrangements. Such other repeating units preferably constitute from 0 to 10%, especially from 0 to 5%, by weight of the PLA resin. The PLA resin is generally devoid of such other repeating units.

The PLA resin may also contain residues of an initiator compound, which is often used during the polymerization process to provide control over molecular weight. Suitable such initiators include, for example, water, alcohols, glycol ethers, polyhydroxy compounds of various types (such as ethylene glycol, propylene glycol, polyethylene glycol, polypropylene glycol, glycerine, trimethylolpropane, pentaerythritol, hydroxyl-terminated butadiene polymers and the like).

The PLA resin advantageously has a number average molecular weight of from about 80,000-150,000, especially about 95,000 to about 120,000, as measured by GPC against a polystyrene standard. The PLA resin advantageously exhibits a relative viscosity of about 3.4 to about 4.5, especially from 3.6 to about 4.2, as measured in methylene chloride at 30° C.

A particularly suitable process for preparing PLA by polymerizing lactide is described in U.S. Pat. Nos. 5,247,059, 5,258,488 and 5,274,073. This preferred polymerization process typically includes a devolatilization step during which the free lactide content of the polymer is reduced, preferably to less than 1% by weight, and more preferably less than 0.5% by weight. In order to produce a melt-stable lactide polymer, it is preferred to remove or deactivate the catalyst at the end of the polymerization process. This can be done by precipitating the catalyst or preferably by adding an effective amount of a deactivating agent to the polymer. Catalyst deactivation is suitably performed by adding a deactivating agent to the polymerization vessel, preferably prior to the devolatilization step. Suitable deactivating agents include carboxylic acids, of which polyacrylic acid is preferred; hindered alkyl, aryl and phenolic hydrazides; amides of aliphatic and aromatic mono-and dicarboxylic acids; cyclic amides, hydrazones and bis-hydrazones of aliphatic and aromatic aldehydes, hydrazides of aliphatic and aromatic mono- and dicarboxylic acids, bis-acylated hydrazine derivatives, phosphite compounds and heterocyclic compounds.

The PLA resin may be modified to introduce long-chain branching. This long-chain branching has been found to improve the melt rheology of the polymer, and in particular to improve melt strength. Various methods of introducing long-chain branching have been described, including copolymerizing lactide with an epoxidized fat or oil, as described in U.S. Pat. No. 5,359,026, or with a bicyclic lactone comonomer, as described in WO 02/100921A1; treating the PLA resin with peroxide, as described in U.S. Pat. Nos. 5,594,095 and 5,798,435, and to use certain polyfunctional initiators in its polymerization as described in U.S. Pat. Nos. 5,210,108 and 5,225,521 to Spinu, GB 2277324 and EP 632 081. Recently, acrylic polymers and copolymers containing multiple epoxy groups have been found to be useful branching agents for PLA resins. Examples of such polymers and copolymers are commercially available from Johnson Polymers, Inc. under the trade names Joncryl® 4368 and Joncryl® 4369.

The PLA resin can be compounded with additives of various types, including antioxidants, preservatives, catalyst deactivators, stabilizers, plasticizers, fillers, nucleating agents, colorants of all types and blowing agents. In the preferred embodiment, in which clear bottles are produced, the PLA resin is preferably devoid of additives that cause the resin to whiten (due to crystallization) or become opaque. A preferred additive is a particulate material such as carbon black, which if used in very small quantities does not cause whitening or opacity, while aiding the ISBM (in particular the two-step) process by absorbing infrared radiation and increasing preform heating rates.

The PLA resin may be co-injected with a polymer that has barrier properties, in order to make a preform and resultant container having a barrier polymer layer that makes the container more resistant to moisture and other vapor transmission. Examples of polymers having suitable barrier properties include polyethylene or copolymers of ethylene, polypropylene or copolymers of propylene, polyvinylidene chloride or copolymers of vinylidene chloride, ethylenevinyl alcohol copolymers, polyethylene terephthalate, polycarbonates, polyamides and similar polymers.

It is of particular interest to produce clear bottles using the invention. Clarity is conveniently expressed in terms of % haze, which can be measured according to ASTM D-1003. Bottles produced in accordance with the invention preferably have a haze of no greater than 20%, more preferably no greater than 15% and even more preferably no more than 10%.

The following examples are provided to illustrate the invention but are not intended to limit the scope thereof. All parts and percentages are by weight unless otherwise indicated. Molecular weights are determined by GPC in tetrahydrofuran against a polystyrene standard.

### EXAMPLE 1

1.5 L bottles are prepared from various PLA resins in a two-step ISBM process as follows. Preforms having a length of 129 mm, an average diameter of 23 mm and weights of 42-44 grams are injection molded by heating the resin to a temperature of 200-210° C. and injecting it into a preform mold. The molding conditions are optimized to produce minimal part stress and to produce clear parts free of haze. The molded preforms are cooled to room temperature before stretch blow molding in a separate step.

Stretch blow molding is performed on a laboratory scale machine capable of producing approximately 2400 bottles/hour at full rates. The preforms are heated with infrared lamps to a temperature of about 98-110° C., inserted into the mold, pre-blown at a pressure of about 10 bar (1 MPa), and then stretched and blown at a pressure of 38 bar (3.8 MPa). The mold temperature is 100° F. (38° C.), except at the base of the mold which is chilled to 40° F. (4° C.). Stretch ratios are: axial stretch ratio=2.1; hoop stretch ratio=4.0; areal stretch ratio=8.4.

The PLA resins used are:

1. Resin 1, a copolymer of 96.5% L- and 3.5% D-lactide having a number average molecular weight of about 105,000.

2. Resin 2, a copolymer of 96% L- and 4% D-lactide having a number average molecular weight of about 105,000.

Under these conditions, Resins 1 and 2 process well at rates of 2300-2400 bottles/hour to make good quality, clear bottles.

### EXAMPLE 2

Sixteen ounce carbonated soft drink bottles are prepared from various PLA resins in a two-step IBSN process as follows. Preforms having a length of 68.2 mm, a reference inside diameter of 15.7 mm, a reference outside diameter of 22.4 mm and a weight of ˜24 grams are injection molded by heating the resin to a temperature of 205-225° C. and injecting it into the preform mold.

Stretch blow molding is performed on a laboratory scale machine capable of producing approximately 1200 bottles/hour at full rates. The preforms are heated with infrared lamps to a temperature of about 85-90° C., inserted into the mold, pre-blown at a pressure of about 20 bar (2 MPa), and then stretched and blown at a pressure of 38 bar (3.8 MPa). The mold temperature is 120° F. (49° C.), except at the base of the mold which is chilled to 40° F. (4° C.). Stretch ratios are: axial stretch ratio=2.2; hoop stretch ratio=3.7; areal stretch ratio=8.1.

Preform temperatures are then varied to determine for each resin the range of preform temperatures at which good quality bottles can be prepared at the stated production rate. Bottle quality is evaluated by examining the bottles for the appearance of stress whitening, thin walls at the base, thin side walls and the development of a resin slug at the center of the base.

The resins are as follows:

Resin 3: a copolymer of 96.8% L- and 3.2% D-lactide having a number average molecular weight of about 102,000 and a relative viscosity of 3.99.

Resin 4: a copolymer of 95.9% L- and 4.1% D-lactide having a number average molecular weight of about 103,500 and a relative viscosity of ˜4.00.

Resin 5: a copolymer of 95.1% L- and 4.9% D-lactide having a number average molecular weight of about 101,000 and a relative viscosity of 3.6.

Resin 6: a copolymer of 95.7% L- and 4.3% D-lactide having a number average molecular weight of about 83,000 and a relative viscosity of 3.29.

Resin 7: a copolymer of 95.3% L- and 4.7% D-lactide having a number average molecular weight of about 80,000 and a relative viscosity of 3.23.

Good quality bottles are prepared using each of Resins 3-7. However, significant differences in processing windows are seen. Resins 3 and 4 exhibit the widest processing windows, both producing good quality bottles at preform temperatures from about 88-95° C. Resin 5, having a higher content of D-isomer and slightly lower molecular weight and relative viscosity, has a processing window from about 87-91.5° C., a range of about 4.5° C. Resins 6 and 7, which have lower D-isomer contents but lower molecular weights than Resin 5, also have processing windows of about 4.5-5° C.

### EXAMPLE 3

A particulate copolymer of 82.5% L- and 17.5% D-lactide is dry blended with a particulate copolymer of 98.6% L- and 1.4% D-lactide. Ratios of the starting materials are selected so the blend has an average ratio of L-:D-enantiomer of 96.8:3.2.

One-liter straightwall bottles are prepared from various PLA resins in a two-step ISBM process as follows. Preforms having weights of ˜29 grams are injection molded. The molded preforms are cooled to room temperature before stretch blow molding in a separate step.

Stretch blow molding is performed on a laboratory scale machine at a rate of approximately 1200 bottles/hour. The preforms are heated with infrared lamps to a temperature of about 83° C., inserted into the mold, pre-blown at a pressure of about 5 bar (0.5 MPa), and then stretched and blown at a pressure of 40 bar (4 MPa). The mold temperature is 100° F. (38° C.). Stretch ratios are: axial stretch ratio =2.3; hoop stretch ratio=4.35; areal stretch ratio=10.0.

Ten of the bottles are dimensionally measured for height, major diameters and overfill volume after aging for 24 hours at ambient conditions. The bottles are then subjected to 100° F. (38° C.) and 100% relative humidity for 24 hours, and the dimensions are remeasured. The bottles show an average shrinkage of 1.03%.

Bottles made in the same manner, except that a single PLA resin containing 96.8% of the L-enantiomer and 3.2% of the D-enantiomer is used, exhibit a shrinkage of 1.19% on the same test.

More bottles are made, this time using a blend of the same starting resins at ratios that produce an average ratio of L-:D-enantiomer of 96:4 in the blended resin. These bottles exhibit a shrinkage of 1.16%. Bottles made using a single PIA resin having an L-:D-enantiomer ratio of 96:4 exhibit a shrinkage of 1.32%.

It will be appreciated that many modifications can be made to the invention as described herein without departing from the spirit of the invention, the scope of which is defined by the appended claims.

1. An injection stretch blow molding process for making containers of a thermoplastic resin, in which a thermoplastic resin is molded into a preform, and the preform is mechanically stretched and blown in a container mold to stretch the preform axially and radially to form a container, wherein (1) the thermoplastic is a polylactic acid (PLA) resin which is (a) a copolymer containing at least 95% by weight of repeating L and D lactic acid units, in which either the L or D lactic acid units are the predominant repeating units, or (b), a blend of such copolymers, wherein the predominant repeating units in the copolymer or blend constitute 94-99% of the lactic acid enantiomer repeating units in the PLA resin or blend and (2) the product of axial and radial stretch ratios is from about 3 to about 17.5.

2. The process of claim 1, after the resin is molded into a preform, the preform is mechanically stretched and blown in a container mold after the preform is molded but before the molded preform is cooled to below the softening temperature of the resin.

3. The process of claim 1, wherein the containers are clear containers.

4. The process of claim 3 wherein the PLA resin has a number average molecular weight of 80,000-150,000, as measured by gel permeation chromatography using a polystyrene standard.

5. The process of claim 4 wherein the PLA resin has a relative viscosity, in methylene chloride at 30° C., of from 3.4 to 4.5.

6-7. (canceled)

8. The process of claim 2, wherein the container mold is at a temperature below the glass transition temperature of the PLA resin.

9. The process of claim 2, wherein the container mold is at a temperature above the glass transition temperature and below the melting temperature of the PLA resin.

10. The process of claim 9, wherein the container is heat set in the container mold.

11. The process of claim 2, wherein the PLA resin is co-injected with a barrier polymer to form a preform having at least one layer of a barrier polymer, and the preform is stretch blow molded to form a container having at least one layer of the barrier polymer.

12. The process of claim 11, wherein the barrier polymer is a polyethylene or copolymer of ethylene, polypropylene or a copolymer of propylene, polyvinylidene chloride or copolymer of vinylidene chloride, an ethylene-vinyl alcohol copolymer, polyethylene terephthalate, a polycarbonate or a polyamide.

13. The process of claim 1 wherein the preform is heated from below to above the glass transition temperature of the thermoplastic resin and then mechanically stretched and blown in a container mold.

14. The process of claim 13, wherein the containers are clear containers.

15. The process of claim 14 wherein the PLA resin has a number average molecular weight of 80,000-150,000, as measured by gel permeation chromatography using a polystyrene standard.

16. The process of claim 15 wherein the PLA resin has a relative viscosity, in methylene chloride at 30° C., of from 3.4 to 4.5.

17-18. (canceled)

19. The process of claim 13, wherein the container mold is at a temperature below the glass transition temperature of the PLA resin.

20. The process of claim 13, wherein the PLA resin is co-injected with a barrier polymer to form a preform having at least one layer of a barrier polymer, and the preform is stretch blow molded to form a container having at least one layer of the barrier polymer.

21. The process of claim 20, wherein the barrier polymer is a polyethylene or copolymer of ethylene, polypropylene or a copolymer of propylene, polyvinylidene chloride or copolymer of vinylidene chloride, an ethylene-vinyl alcohol copolymer, polyethylene terephthalate, a polycarbonate or a polyamide.

22. The process of claim 13, wherein the container mold is at a temperature above the glass transition temperature and below the melting temperature of the PLA resin.

23. The process of claim 2, wherein the PLA resin contains from 0-10% by weight of repeating units derived from a monomer that is copolymerizible with lactide or lactic acid.

24. The process of claim 13, wherein the PLA resin contains repeating units derived from a monomer that is copolymerizible with lactide or lactic acid.
